(19) United States
(12) Patent Application Publication
(10) Pub. No.: US 2005/0038541 A1
(43) Pub. Date: Feb. 17, 2005

(54) Method and apparatus of manufacturing

(76) Inventors: Lawrence W. Clark, Morton, IL (US); Robert W. Rodgerson, Simpsonville, SC (US)

Correspondence Address: CATERPILLAR INC.;100 N.E. ADAMS STREET, PATENT DEPT., PEORIA, IL, 616296490, US

(21) Appl. No.: 10/628,155

(22) Filed: Jul. 28, 2003

(51) Int. Cl. G06F 19/00

(52) U.S. Cl. 700/105; 700/95; 700/111

(57) ABSTRACT

A method of operating a manufacturing line by establishing a fluid change in a manufacturing characteristic, enabling a manufacturing instruction in response to a changed manufacturing characteristic and displaying a changed manufacturing instruction of a manufacturing component.

### TECHNICAL FIELD

The present disclosure is related to a method of providing a manufacturing instruction change to a manufacturing process during and as part of the normal operation of the process. A change is established in a manufacturing characteristic. A change is enabled in a manufacturing instruction in response to the changed manufacturing characteristic. A manufacturing instruction associated with a manufacturing component is sent to a manufacturing station and displayed.

### BACKGROUND

Currently, a change to an operation or instruction associated with a manufacturing/assembly line is performed by manually (e.g. making a change to a paper copy) or electronically (e.g. utilizing a computer to make the change) changing the work order or by uploading the change in a computer system at the beginning of the workday. This manner of making changes does not allow for a real-time, immediate or moderate timely change. An engineer may perform the change during his normal work shift (e.g. the engineer works from 9 a.m. to 5 p.m. and makes the change during that time period). A problem is the engineer is only able to upload the information to the computer system off-shift (e.g. after 5 p.m.), or when the manufacturing line in not running. This method does not allow for a fluid flow of timely information between the change agent (e.g. the engineer) and the manufacture cell operator (e.g. the assembler). This may result in the manufacture of a product with less than current parts, assembly techniques, instructions, and designs. Additionally, using untimely information may result in inadequate manufacturing procedures (e.g. using the wrong amount of torque, assembling components out-of-order, utilizing the wrong instructions, utilizing old instructions, and using the wrong time sequence).

The present invention is directed to overcoming one or more of the problems set forth above.

### SUMMARY OF THE INVENTION

A method of operating a manufacturing line is disclosed. A method includes the steps of establishing a fluid change associated with a manufacturing characteristic, enabling a change in an manufacturing instruction in response to a changed manufacturing characteristic, and displaying a changed manufacturing instruction associated with a manufacturing component on a display screen in a first manufacturing station workstation.

A computing system for use in a manufacturing line is disclosed. The computing system includes, a plurality of workstations, the workstations including a display. The computer system also includes a computer controller connected to the workstation with the computer controller configured to receive a fluid change in a manufacturing instruction associated with a manufacturing line and delivering a manufacturing instruction to one of the workstations in response to a defined event.

### BRIEF DESCRIPTION OF THE DRAWINGS

FIG. 1 is a diagram of a method of manufacturing.

FIG. 2 is a flow chart illustrating the steps of operating a manufacturing line.

FIG. 3 is a diagram of a location of a fluidly changed manufacturing component.

FIG. 4 is a diagram of a storage location of a fluidly changed manufacturing component.

### DETAILED DESCRIPTION

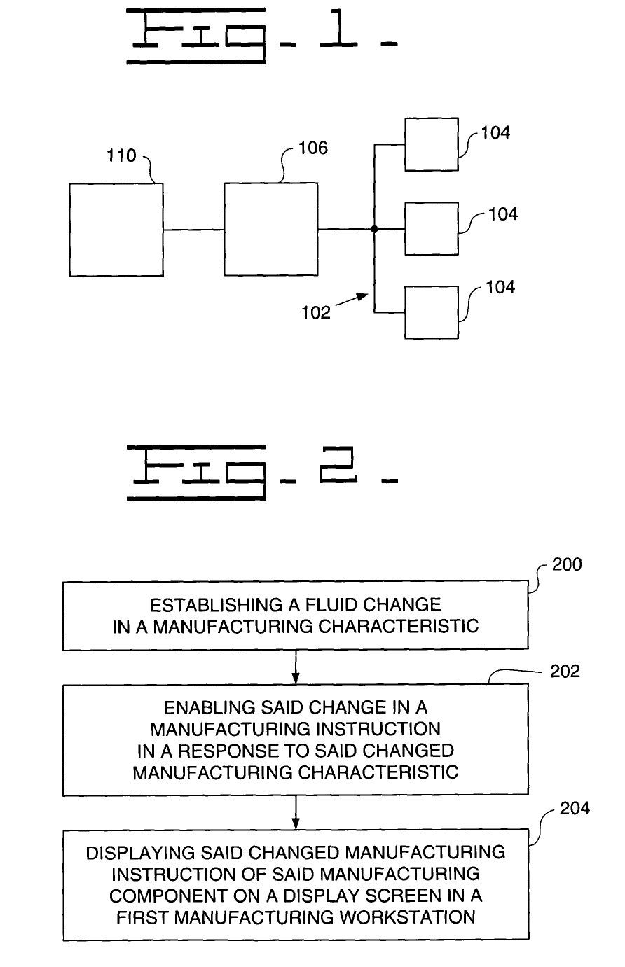

The present disclosure is associated with operating a manufacturing line, as illustrated in FIG. 1. A manufacturing line may include a manufacturing and/or assembly line and a manufacturing/assembly cell. A manufacturing line/cell may be used to facilitate the building of consumer and/or commercial goods.

FIG. 1 illustrates one embodiment of a manufacturing system associated with the present invention. A manufacturing line 102 includes multiple stations where one or more functions associated with the product are performed (e.g. one or more parts are assembled to the product). In addition there may be a workstation 104 located at one or more of the stations, the workstation may be configured to display information to be used by the operator (e.g. the assembler) to assemble the product. A product being assembled may move down the manufacturing line 10.

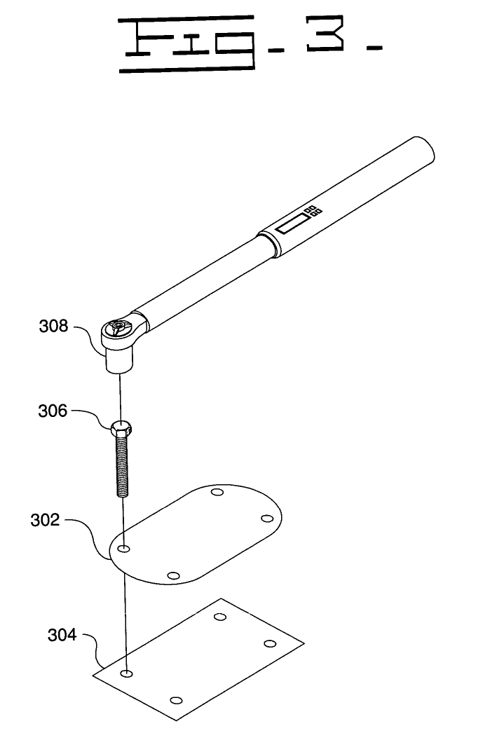

In one embodiment, the progress of a product is tracked such that as a product arrives in a particular station, the appropriate assembly information for that product (and that specific product configuration) is delivered to the workstation 104 from the controller computer 106. In one embodiment, the controller computer 106 is configured to control the assemble instructions associated with the manufacturing line. The computer 106 may include a repository of information associated with the assembly process. Changes to the assembly information may either be provided from an external controller 110, or may be directly entered via the controller computer 106. Therefore, in one embodiment, when a change to the assembly information is desired, the change may be entered into the instructions stored in the data repository associated with the controller computer 106. When the relevant product configuration arrives at a particular station, the modified information may be delivered to the workstation 104 to aid in the assembly of the product. FIG. 2 illustrates one embodiment of a manufacturing system. In a first control block 200 a fluid change in a manufacturing characteristic may be established. A fluid change includes a change without the need to halt the operation of an assembly line. A fluid change may be a change made easily, a change made smooth and effortlessly, an immediate change, a dynamic change, a real-time change, a change that occurs in response to an event, and/or a change with a slight delay (e.g. an engineer in his office changes a manufacturing instruction and the change is conveyed by at least one of, real-time, immediately and/or with a slight delay to the computer terminals and display screens on the manufacturing shop floors).

Manufacturing characteristics may include, but are not limited to, a product, method, and component. A product may include, a finished product (e.g. an engine, a work machine), a manufactured good (e.g. a finished good coming off the assembly line), manipulating raw material (e.g. melting and molding a compound like iron to make an engine block), and a machined product (e.g. a drive shaft milled by a machine). A method may include, a series of commands structured to accomplish a task (e.g. assemble component A first, component B second, component C third), a means of accomplishing a task (e.g. use wrench W to tighten bolt A and wrench X to tighten bolt B), a system (i.e. a group of interrelated, interdependent constituents forming a whole, e.g. hold wrench B on bolt A while using wrench W on nut N), and a regular means of performing a task (e.g. general instructions to assemble components a, b and c). A component may include, a portion of a product (e.g. a piston is a component of an engine), a part (i.e. an o-ring), and a product (e.g. a drive shaft may be both a product and component).

A change to the manufacturing characteristic may be established by identifying or establishing at least one of a defect, component improvement, cost issue and availability, associated with a manufacturing characteristic. For example, a defect may include, a fault (e.g. a crack in engine block), an imperfection (e.g. excess iron on an engine block), and an error in a process (e.g. a manufacture worker assembles component A first and B second, but should have assembled B first and A second). A component improvement may include, an upgrade (e.g. o-ring W is a newer and stronger o-ring than X), a design change (e.g. exhaust pipe B is preferred over exhaust pipe A because of a new enhancement resulting in better performance), a cosmetic change (e.g. exhaust pipe B is more appealing than exhaust pipe A), and raw material change (e.g. make piston out of aluminum alloy instead of steel). A cost issue may include, finding a less expensive component (e.g. piston A cost fifty dollars less than piston B and they are relatively the same), durability (e.g. even though piston A cost fifty dollars more than piston B, it will last five times a long and therefore a higher price may be realized for selling a product with piston A), and identifying a more readily available component at a comparable cost (a component cost the same but is more readily available) (e.g. oil pumps A, B, C, and D are all the same in function, structure and price, however oil pump B is currently overstocked and may be able to ship as many oil pumps as needed for the foreseeable future). Availability may include having the part on-hand or accessible for assembly (e.g. if part P is in another location and not accessible to the assembler when needed but part Q is on location and available to the assembler when needed, use part Q).

A change agent may be responsible for changes to a manufacturing operation (e.g. a change agent may be tasked with insuring a new bolt is used on an oil pump during the manufacturing operation of assembling an engine). A change agent (e.g. a person who instigates the change such as, an engineer, manufacturing shop foreman, inspector, manufacturing specialist, draftsman, sales representative, rental manager, contract manager, dealer) may establish the fluid change (e.g. as a result of a defect in O-ring W on the fuel pump assembly, a manufacturing shop foreman may make a change in the computer system to change the o-ring used to X on the fuel pump assembly at workstation 10) in response to at least one of, the defect, component improvement and cost issue.

Examples of changes in a manufacturing characteristic may include, a change to a component, a change to a manufacturing line workstation, a change to a manufacturing task, and a change to a manufacturing instruction.

A component may include a finished product (e.g. an engine), and/or a component of the finished product (e.g. the pistons of an engine; the engine being the finished product).

A manufacturing line workstation may include a linear assembly station (e.g. a traditional assembly line where a manufactured product moves in a designated direction) (e.g. north-south direction or an east-west direction), and a manufacturing cell (e.g. a work area where the components are brought to the area and a manufactured product is manufactured in at least one of one location and an area encompassing a small area).

A manufacturing task may include instructions for assembling a product (e.g. place bolt A in bolt hole B and torque to 100 psi), instructions for loading a product on a manufacturing line workstation (load engine block 504B on assembly dolly 102 in manufacturing line workstation 4), a method of identifying a product or component to use (e.g. deplete fuel pump X before using fuel pump Y), emphasizing an instruction (e.g. highlighting the instruction with a different color, or bold print so the highlighted or bold instruction stands out over the other instructions and calls attention to itself), and availability of a part or component (e.g. gasket W is currently depleted but gasket Q may be used because both are the same, therefore use gasket Q).

In a second control block 202 a change in a manufacturing instruction is enabled in response to the changed manufacturing characteristic. A manufacturing instruction may include paper (e.g. a printed copy of a set of instructions), video (e.g. a video showing the proper method for an assembler to put part A on part B), audio (a voice telling a manufacturer the proper method to put part A on part B), and digital formats (e.g. AVI files which combine at least two of the above instructions; voice and audio combined).

In a third control block 204 the changed manufacturing instruction is displayed (e.g. a computer, a computer network, the Internet, a data repository, a database, an electronic data interchange, a VPN). The fluid change may be sent and displayed at a first workstation on a manufacturing line (e.g. an engineer in his office changes an instruction for the torque on the bolts of a fuel pump to 50 psi and in response, the change in instructions for the torque on the bolts of a fuel pump are displayed at the fuel pump manufacturing workstation and the changed instructions may be emphasized). The manufacturer (e.g. the assembler) may take action in response to the fluid change to the instructions of the manufacturing characteristic (e.g. the torque for the bolts of a fuel pump to 50 psi) and may manufacture the component (torque the bolts to 50 psi) in response to the fluid change to the manufacturing characteristic.

In an additional embodiment, a manufacturing line may stop if the manufacturing instruction is not performed (e.g. the fluid change to a manufacturing instruction telling manufacturer ((assembler)) as part of his manufacturing function to put part x on part y as opposed to putting part p on part y). An assembler may record a manufacturing function on a computer terminal. A computer terminal may include being connected to a network with computers and data repositories, and connected to the Internet and tied to a dedicated computer system. If a manufacturing function is performed based on a fluid change to a manufacturing instruction, a manufacturing line will continue. If a fluid change to a manufacturing instruction is not performed completely or properly, a manufacturing line may stop. In one embodiment a manufacturing line may not resume without manual intervention once a manufacturing line is stopped. In some instances, there may be justification for not completely or properly performing a manufacturing instruction (e.g. if a part is backordered and if a part is not a foundation part). In these instances, an assembler may manually override a manufacturing function on a computer terminal, allowing a manufacturing line to start and continue operations.

Alternatively, a manufacturing system may record a part as missing and in response update at least one of the manufacturing instructions for a manufacturing station (e.g. a workstation downstream which requires a missing part before being able to add the part associated with the current station). For example, part w is missing, the manufacturing system may update manufacturing instructions m,n,o, and p in response to missing part w, because part w is a foundation part for parts a,b,c, and g. All other parts which may not require w as a foundation part may not require a change to their manufacturing instructions (e.g. part K is assembled on the bottom of the engine and has no relation to part W which is assembled on the top of the engine and is missing, therefore, no change to the instructions are needed for part K, additionally, part B was assembled on the engine before part W is to be assembled on the engine, therefore no change to the instructions are needed to part B because the part is already on the engine). In this manner an assembly of a product may continue, and a missing and dependant part may be later added.

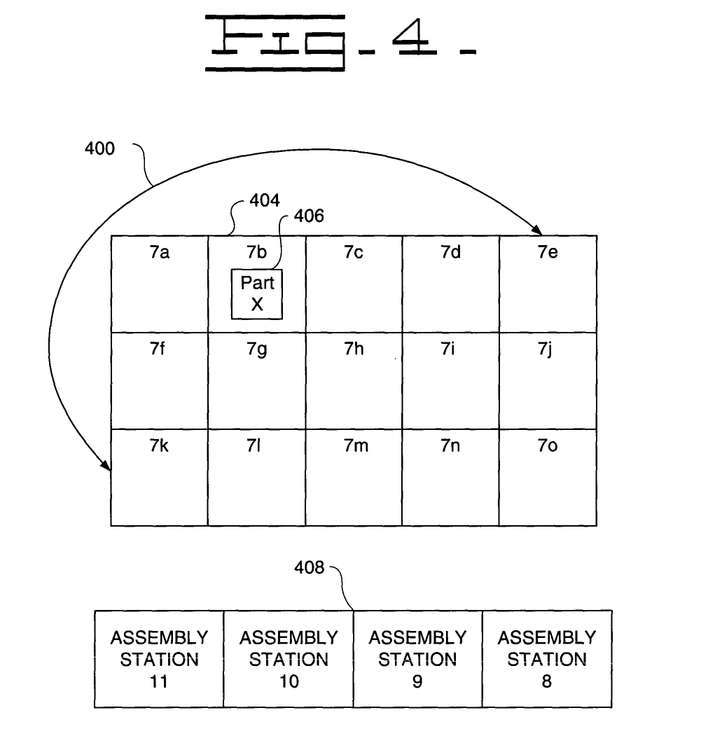

FIG. 3 illustrates one embodiment of displaying changed instructions, or changed components. For example, training AVI (audio video interleave) may show how a changed manufacturing component is assembled on a location (e.g. place component 302 on top of component 304 and secure with fasteners 306, applying 50 psi of torque, using torque tool 308). Alternatively, a pop-up dialog box may be displayed showing a manufacture worker what a new part is, where a new part goes, how to properly assemble a new part, and reminding a manufacture worker of the new change.

FIG. 4 illustrates a storage location of a changed manufacturing component. For example, displaying that part 406 is located in bin location 7b 404 (e.g. further showing where location 7b 404 is in relation to other bins 400 and a manufacturing station 408). This allows a manufacturing worker faster access to parts and a more likely chance that a manufacturing worker obtains a correct part, since he is directed to a proper storage location.

In one embodiment, the inventory of a manufacturing component is exhausted before a changed manufacturing component is first used in response to a changed manufacturing instruction (e.g. the changed manufacturing instruction may require fuel injector F to be replaced by fuel injector R). In one embodiment a changed manufacturing instructions may inform a manufacturing worker to deplete the inventory of fuel injector F before first installing fuel injector R. However, in cases of poor performance, a changed manufacturing instruction may require a manufacturing worker to use fuel injector R and stop using fuel injector F.

In one embodiment, when a manufacturing instruction is changed, a manufacturing component affected by a change may be ordered (e.g. a changed manufacturing instruction calls for fuel injector F to be used immediately, replacing fuel injector R in which case fuel injector F would be ordered from supplier Q and in sufficient quantity to satisfy a change in a manufacturing instruction). Additionally, orders for fuel injector R may be halted because fuel injector R would no longer be needed. A component may be ordered electronically or by a computer system (e.g. a network of computers connected via the Internet, a dedicated network or combination of data repositories and computers).

In one embodiment a computer sends a changed manufacturing instruction associated with a manufacturing component from a data repository to a display screen on a first manufacturing workstation in preparation for a manufacturing operation. At least one of, a computer, a computer network, the Internet and a dedicated computer network system may be the conduit for sending the changed manufacturing instruction. A display screen may include, a monitor, a flat screen, a television, a digital phone, a pager, a digital messaging device and a palm pilot. A change is sent in a timely manner (e.g. because computer networks may update at various times even if the intent is to update instantaneously or as close to instantaneously as possible, the change may occur within one second or may occur within an industry standard for reasonableness for the real-time updating of information). This method is also known in the industry as an information-pushing request.

In an alternative embodiment, a changed manufacturing instruction associated with a manufacturing component may be pulled by a first manufacturing workstation from a data repository. A changed manufacturing instruction may be pulled by a command carried via at least one of, a computer network, the Internet, a dedicated computer system and VPN. A command by a first manufacturing workstation may instruct a data repository to send a changed manufacturing instruction to a first manufacturing workstation in response to a pulling request. This method is known in the industry as an information-pulling request.

In one embodiment a changed manufacturing instruction may be displayed in response to a defined event may be displayed. A defined event may include, time (e.g. display a change at 10 a.m. or display an emphasized change for the next three days, then discontinue displaying the emphasized change), availability (e.g. because there are no more fuel pump B's start using fuel pump C), identification of a manufacturing cell operator (e.g. when operator W is identified, display instruction B, when operator X is identified, display instruction A), identification of a manufacturing product transport (e.g. the cart (D₁) in which engine block 10 sits as the engine moves down an assembly line, when cart D₁ arrives display instruction number 5), and identification of a manufacturing product (e.g. when engine block 10 arrives display instruction number 5, when engine block 11 arrives display instruction number 6).

In one embodiment a manufacturing instruction may be emphasized in response to an event (i.e. such as the above referenced list, e.g. 10 a.m. on Monday). An emphasis may be at least one of, highlighting an instruction or portion of an instruction in a different color (e.g. highlighting an instruction change in yellow), utilizing a different font type (e.g. using a larger font on a changed portion of the instruction), utilizing bold face type on a changed portion of the instruction, increasing a volume or tone of a changed instruction (e.g. if an instruction is on an audio file, a voice may be increased to attract attention of a manufacturing operator), signaling with a pointing device (e.g. a hand points to a location of a new location for a part), and utilizing animation (e.g. an animation of how to assemble a new part).

In one embodiment the system performs operator identification. For example, a manufacturing worker may badge into a computer system, which may be at his workstation. In response to this, unique sets of manufacturing instructions are displayed to that particular worker (e.g. worker x badges into a computer system, in response instructions q with a new fuel pump assembly are responsively highlighted, as distinguished by worker y who badges into a computer system and in response instruction r is responsively displayed with no highlighted changes). A reason worker x receives a highlighted change as opposed to worker y may include, worker x is new to a position (e.g. he just hired into a company or he is new to that particular manufacturing position), a worker needs job reinforcement (e.g. at a set period of time a manufacturing worker receives reinforcement training, for instance every six months and his six month period has arrived), a worker missed an earlier meeting or training session (previously at a meeting or training session new manufacturing instructions were given on how to assemble a new fuel pump and he was absent), the worker does not know of a change (e.g. a change recently occurred and a worker is unaware), and the worker missed a change previously (e.g. on a previous manufacturing assembly a worker did not perform a new change correctly, therefore a change is being highlighted). In an additional embodiment a manufacturing worker may be asked to badge in right before a new instruction is to be utilized (e.g. a worker at station 10 is prompted to badge in because an assembly operation at work station 10 has changed and depending on whether or not the current worker at work station 10 knows of the change will determine which set of instructions is displayed).

1. A method of operating a manufacturing line comprising the steps of:
establishing a fluid change associated with a manufacturing characteristic;
enabling said change in a manufacturing instruction in response to said changed manufacturing characteristic; and
displaying said changed manufacturing instruction associated with a manufacturing component on a display screen in a first manufacturing workstation.

2. The method as set forth in claim 1, further comprising the step of stopping said manufacturing line if said changed manufacturing instruction is not performed.

3. The method as set forth in claim 1, further comprising the step of changing a manufacturing instruction associated with a second manufacturing station in response to not performing said changed manufacturing instruction.

4. The method as set forth in claim 1, further comprising the step of displaying a location of said changed manufacturing component.

5. The method as set forth in claim 1, further comprising the step of exhausting said manufacturing component before using a changed manufacturing component in response to said changed manufacturing instruction.

6. The method as set forth in claim 1, further comprising the step of ordering said manufacturing component in response to said changed manufacturing instruction.

7. The method as set forth in claim 1, further comprising the step of sending said changed manufacturing instruction associated with said manufacturing component to a display screen on a first manufacturing workstation in preparation for a manufacturing operation.

8. The method as set forth in claim 1, further including the step of a first manufacturing workstation pulling said changed manufacturing instruction of said manufacturing component from a repository.

9. A method of operating a manufacturing cell further comprising the steps of:
establishing a change in a manufacturing characteristic;
enabling a fluid change in a manufacturing instruction in response to said manufacturing characteristic change; and
displaying said changed manufacturing instruction in response to a defined event occurring.

10. The method as set forth in claim 9, wherein the step of displaying said manufacturing instruction further includes the step of emphasizing said manufacturing instruction in response to said event.

11. The method as set forth in claim 10, further comprising the step of discontinuing the emphasis in response to a second event.

12. A computing system for use in a manufacturing line comprising:
a plurality of work stations, said workstations including a display;
a computer controller connected to said workstation;
said computer controller configured to receive a fluid change in a manufacturing instruction associated with said manufacturing line and delivering said manufacturing instruction to one of said work stations in response to a defined event.
